(19) United States
(12) Patent Application Publication
(10) Pub. No.: US 2026/0247028 A1
(43) Pub. Date: Aug. 20, 2026

(54) CONTROL DEVICE, METHOD FOR CONTROLLING IMAGING DEVICE, AND STORAGE MEDIUM

(71) Applicant: CANON KABUSHIKI KAISHA, Tokyo (JP)

(72) Inventor: TAKAYUKI SHU, Kanagawa (JP)

(21) Appl. No.: 19/535,928

(22) Filed: Feb. 10, 2026

(30) Foreign Application Priority Data
Feb. 14, 2025 (JP) 2025-022760

(51) Int. Cl. H04N 23/63; H04N 23/667; H04N 23/73; H04N 23/74

(52) U.S. Cl. CPC H04N 23/633; H04N 23/667; H04N 23/73; H04N 23/74

(57) ABSTRACT

A control device includes an acquisition unit configured to acquire information regarding an emission frequency of a light emission device, and a determination unit configured to determine imaging settings, wherein the determination unit determines an upper limit of a shutter speed that is settable among the imaging settings based on the information.

### BACKGROUND

### Field of the Technology

The aspect of the embodiments relates to a control device, a method for controlling an imaging device, and a storage medium.

### Description of the Related Art

Some conventional imaging methods include high-speed synchronization (sync) photography, in which a flash performs flat light emission (i.e., emission produced by repeatedly turning a switching element on and off to obtain a substantially flat light output waveform) to provide exposure during slit exposure at a camera shutter speed faster than the flash synchronization speed. In such cases, uneven brightness caused by flat light emission tends to appear in the captured image. To address this issue, Japanese Patent Laid-Open No. 1997-127582 describes a technique in which a flash determines the pulse cycle for flat light emission based on the shutter speed information about the camera.

However, there is an upper limit to the light emission pulse cycle that can be set for the flash, so that in the technique described in Japanese Patent Laid-Open No. 1997-127582 uneven brightness may appear in the captured image depending on the shutter speed of the camera.

### SUMMARY

According to an aspect of the embodiments, a control device includes an acquisition unit configured to acquire information regarding an emission frequency of a light emission device, and a determination unit configured to determine imaging settings, wherein the determination unit determines an upper limit of a shutter speed that is settable among the imaging settings based on the information.

Features of the disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an imaging system according to the first embodiment.

FIG. 2 is a characteristic diagram for illustrating a general relationship between flat light emission and imaging by an image sensor in a camera.

FIG. 3 is a characteristic diagram illustrating a relationship between flat light emission during high-speed switching of the switching element and imaging by the image sensor of the camera.

FIG. 4 is a sequence diagram for setting an upper limit of a shutter speed based on information acquired by the camera from a flash in the imaging system according to the first embodiment.

FIG. 5 is a flowchart for setting the upper limit of the shutter speed based on flat light emission frequency acquired by the camera from the flash according to the first embodiment.

FIG. 6 is a flowchart illustrating a process for setting the upper limit of the shutter speed based on the flat light emission frequency acquired by the camera from the flash according to a modification of the first embodiment.

FIG. 7 is a flowchart for setting the upper limit of the shutter speed based on flag information indicating whether the flat light emission frequency of the flash, acquired by the camera from the flash, is a predetermined high speed, according to a second embodiment.

FIG. 8 is a flowchart for setting the upper limit of the shutter speed based on flag information indicating whether the flat light emission frequency of the flash, acquired by the camera from the flash, is a predetermined high speed, according to a modification of the second embodiment.

### DESCRIPTION OF THE EMBODIMENTS

Hereinafter, various embodiments of the disclosure will be described in detail with reference to the accompanying drawings. The following embodiments do not limit the disclosure according to the scope of the claims. Although a plurality of features is described in the embodiments, not all of these features are necessarily essential, and the

features may be combined as appropriate. Furthermore, in the drawings, the same or similar configurations are assigned the same reference numerals, and redundant descriptions are omitted. The dimensions and structural details illustrated in each embodiment are not limited to those described in the specification and drawings.

### First Embodiment

A first embodiment will be described.

### Imaging System Configuration

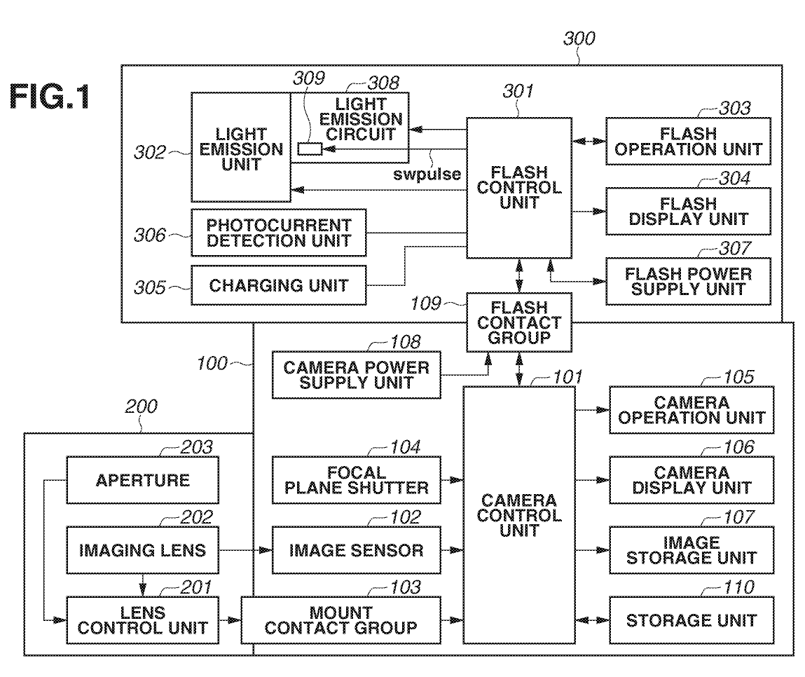

FIG. 1 is a schematic diagram illustrating an imaging system according to the first embodiment.

The imaging system according to the embodiment includes a camera 100 serving as an imaging device, a lens 200 serving as an optical device, and a flash 300 serving as a light emission device.

As illustrated in FIG. 1, the lens 200 is mounted on a front surface of the camera 100. The lens 200 is replaceable, and the camera 100 and the lens 200 are electrically connected via a mount contact group 103. The flash 300 is mounted on an upper surface of the camera 100. The flash 300 is replaceable, and the camera 100 and the flash 300 are electrically connected via a flash contact group 109.

### Configuration of Camera 100

The configuration of the camera 100 will be initially described.

A camera control unit 101 includes a central processing unit (CPU; microcomputer), and integrally controls the components of the camera 100 and performs various settings in accordance with a computer program loaded from a storage unit 110. The storage unit 110 stores computer programs that control the camera control unit 101. In the imaging system illustrated in FIG. 1, an imaging control device according to the embodiment is configured to include the camera control unit 101.

An image sensor 102 converts light, from a subject, that enters through an imaging lens 202 into electrical signals to generate image data, and outputs the image data to the camera control unit 101.

A focal plane shutter 104 is disposed between the image sensor 102 and the imaging lens 202, and operates in response to instructions from the camera control unit 101. The focal plane shutter 104 includes a front curtain and a rear curtain. Exposure of the image sensor 102 starts when the front curtain moves to open the shutter, and ends when the rear curtain moves to close the shutter.

A camera operation unit 105 includes operation components operated by a user, and detects operations performed by the user via buttons, switches, dials, connected devices, and the like attached to the camera 100, and transmits signals corresponding to operation instructions to the camera control unit 101. The camera operation unit 105 outputs an instruction signal (hereinafter referred to as an SW1 signal) which is issued when the user performs a half-press operation on a release button, and outputs an instruction signal (hereinafter referred to as an SW2 signal) which is issued when the user performs a full-press operation by deeply pressing the release button, both to the camera control unit 101.

A camera display unit 106 displays information about imaging and captured images in response to instructions from the camera control unit 101.

The camera control unit 101 controls the operation of the camera 100 based on output signals from the camera operation unit 105. In a case where the operation unit 105 outputs the SW1 signal, the camera control unit 101 drives the image sensor 102 to capture an image, and repeatedly performs exposure metering control (auto exposure [AE] operation) to measure the luminance of the subject from the captured image, and determines, based on the exposure metering result, the shutter speed, aperture value, and ISO sensitivity to be used during imaging. Herein, the shutter speed, aperture value, and ISO sensitivity to be used during imaging are collectively referred to as exposure control values. The determined exposure control values are displayed on the screen of the camera display unit 106.

In a case where the camera operation unit 105 outputs the SW2 signal, the camera control unit 101 drives the aperture of the imaging lens 202, sets the sensitivity (ISO sensitivity) of the image sensor 102, and controls the focal plane shutter 104 to irradiate the image sensor 102 with light. The camera control unit 101 performs control to display a captured image on the screen of the camera display unit 106 in accordance with image data acquired from the image sensor 102, and to write the image data to the image storage unit 107.

In the embodiment, the camera control unit 101 acquires information regarding the flat light emission frequency of the flash 300 from a flash control unit 301 via the flash contact group 109. As used herein, the term "flat light emission" refers to emission produced by repeatedly turning a switching element on and off to obtain a substantially flat light output waveform. The camera control unit 101 determines an upper limit of the shutter speed that can be set in the focal plane shutter 104 based on the acquired information regarding the flat light emission frequency. The information regarding the flat light emission frequency is either the flat light emission frequency of the flash 300 or flag information regarding the flat light emission frequency of the flash 300.

In a case where the information regarding the flat light emission frequency is the flat light emission frequency of the flash 300, the camera control unit 101 determines the upper limit of the shutter speed based on the magnitude relationship between the flat light emission frequency of the flash 300 and a predetermined threshold. Specifically, if the flat light emission frequency is less than the predetermined threshold, the upper limit of the shutter speed is set to a first value (e.g., shspdmax1 in the embodiment). If the flat light emission frequency is equal to or greater than the predetermined threshold, the upper limit of the shutter speed is set to a second value (e.g., shspdmax2 in the embodiment) which is higher than the first value.

It may be configured to set the upper limit of the shutter speed to the first value in a case where the camera control unit 101 cannot acquire the flat light emission frequency.

The camera control unit 101 may also determine the upper limit of the shutter speed based on both the magnitude relationship between the flat light emission frequency of the flash 300 and the predetermined threshold, and on the efficiency of the shutter mode set for the focal plane shutter 104.

In contrast, in a case where the information regarding the flat light emission frequency is flag information for the flat light emission frequency of the flash 300, the following process is performed. The camera control unit 101 determines the upper limit of the shutter speed based on whether the flag information corresponds to a value indicating that the flat light emission frequency of the flash 300 is a predetermined high speed. Specifically, if the flag information is a value set based on a determination that the flat light emission frequency of the flash 300 is not a predetermined high speed, the upper limit of the shutter speed is set to a first value (e.g., shspdmax1 in a second embodiment). If the flag information is a value set based on a determination that the flat light emission frequency of the flash 300 is a predetermined high speed, the upper limit of the shutter speed is set to a second value (e.g., shspdmax2 in the second embodiment) that is higher than the first value. If the camera control unit 101 cannot acquire the flag information, the upper limit of the shutter speed may be set to the first value.

The camera control unit 101 may also determine the upper limit of the shutter speed based on both the determination of the flat light emission frequency of the flash 300 in the flag information and the efficiency of the shutter mode set in the focal plane shutter 104.

The embodiment exemplifies a case in which the camera control unit 101 directly acquires information regarding the flat light emission frequency of the flash 300 from the flash 300, but the disclosure is not limited thereto. For example, the camera control unit 101 may acquire a signal for identifying the flash 300 from the flash 300, and, based on the signal, refer to a table or other types of data stored in the storage unit 110 to acquire information regarding the flat light emission frequency of the flash 300.

In the camera 100 according to the embodiment, a photographer can selectively set the shutter mode of the focal plane shutter 104. Specifically, as the shutter mode, any or all of a mechanical shutter mode, an electronic shutter mode, and an electronic front curtain shutter mode can be appropriately set. In this embodiment, all of these shutter modes can be appropriately set. In the mechanical shutter mode, the focal plane shutter 104 is controlled to open and close to control exposure of the image sensor 102. In the electronic shutter mode, the focal plane shutter 104 is maintained in an open state, and exposure is controlled electronically within the image sensor 102. In the electronic front curtain shutter mode, the front curtain shutter is controlled electronically within the image sensor 102, and after a predetermined time interval, the rear curtain of the focal plane shutter 104 is closed to end exposure.

A camera power supply unit 108 includes a battery and is configured with an electric circuit for supplying power to each component of the camera 100.

### Configuration of Lens 200

Next, the configuration of the lens 200 will be described.

A lens control unit 201 includes a CPU (microcomputer) and controls the operation of each component of the lens 200. An imaging lens 202 includes a plurality of lenses and forms an image of a subject on the image sensor 102. Furthermore, the imaging lens 202 includes an aperture 203 for adjusting the amount of light and a focus lens (not illustrated) for adjusting focus.

The lens control unit 201 adjusts the amount of light entering the camera 100 and the focus position in accordance with instructions from the camera control unit 101, under control via the mount contact group 103.

### Configuration of Flash 300

Next, the configuration of the flash 300 will be described.

A flash control unit 301 includes a CPU (microcomputer) and controls the operation of each component of the flash 300. The flash control unit 301 can communicate with the camera control unit 101 via the flash contact group 109, and can receive flash emission control instructions and camera information from the camera 100 and transmit flash information to the camera 100. A light emission unit 302 includes a discharge tube, a light emission circuit, and a light emission optical system.

A charging unit 305 uses power supplied from a battery (not illustrated) mounted in the flash 300 to charge a capacitor (not illustrated) with energy for generating light with which a subject to be imaged is to be irradiated. The charging operation is controlled by the flash control unit 301, which, during this process, detects the voltage charged in the capacitor and stops the charging operation when the voltage reaches or exceeds a predetermined voltage threshold (charging complete). When the voltage falls below the predetermined voltage threshold, the flash control unit 301 starts the charging operation. Charging voltage and charging completion flag information are transmitted to the camera control unit 101 via the flash contact group 109.

A flash operation unit 303 includes operation components operated by a user, and detects user operations via buttons and dials provided on the main body of the flash 300, and transmits signals corresponding to the operation instructions to the flash control unit 301. A flash display unit 304 displays emission modes and other settings in response to instructions from the flash control unit 301.

A flash power supply unit 307 includes a battery and is configured with an electric circuit for supplying power to each component of the flash 300.

The flash control unit 301 drives a light emission circuit 308 including a switching element 309, which discharges the energy charged in a light emission capacitor to the discharge tube to cause the light emission unit 302 to emit light, thus irradiating the subject with light via the light emission optical system.

In response to the flash control unit 301 performing a predetermined control operation on the light emission circuit 308 and turning on the switching element 309, the light emission unit 302 emits light. In response to the flash control unit 301 turning off the switching element 309 thereafter, the light emission stops. The control signal for the switching element 309 is referred to as swpulse.

There are two types of light emission: flash emission, in which the switching element 309 is turned on once, and flat light emission, in which the switching element 309 is repeatedly controlled to turn on and off.

The amount of light emission from the light emission unit 302 is monitored by the flash control unit 301 via a photocurrent detection unit 306. When a predetermined amount of light emission is detected, the flash control unit 301 stops the light emission. In the photocurrent detection unit 306, a photodiode, a circuit for integrating the current generated by the photodiode and converting it into voltage, and other components are arranged. In flash emission, the flash control unit 301 determines whether the predetermined amount of light has been applied by comparing the photocurrent or the integrated voltage of the photocurrent with a predetermined threshold.

In flat light emission, the flash control unit 301 compares the photocurrent with a predetermined peak threshold to determine whether the predetermined amount of light has been emitted, and based on the determination, turns off the switching element.

Turning off the switching element results in a gradual decrease in the light amount. The flash control unit 301 compares the photocurrent with a predetermined bottom threshold to determine whether the light amount has decreased to a predetermined amount of light, and based on the determination, turns on the switching element. Repeatedly controlling the switching element 309 to turn on and off in this manner produces light emission with a substantially flat profile. The camera 100 determines the duration of flat light emission based on the set shutter speed, and then communicates information about the determined duration to the flash 300 to control the flash 300.

An example of the switching element 309 is an Insulated Gate Bipolar Transistor (IGBT). The IGBT is typically used as a switching element for flashes. The switching frequency at which the IGBT can operate is approximately 50 kHz. Thus, during flat light emission, a difference in light and dark intensity occurs at a frequency of 50 kHz.

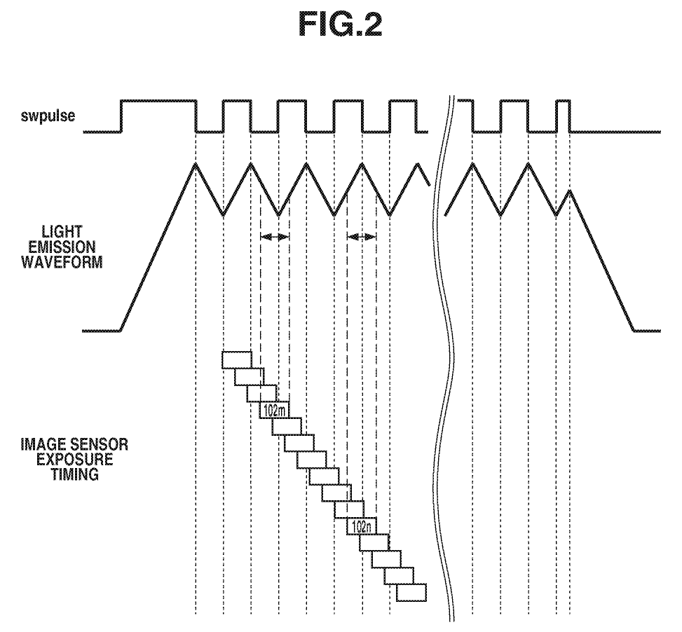

The general relationship between flat light emission and image-capturing by an image sensor in a camera will be described with reference to FIG. 2.

In accordance with the on/off control of the switching control signal swpulse for a switching element, the waveform of light emission from a flash repeatedly alternates between bright and dark states. In FIG. 2, a portion corresponding to an image sensor indicates the exposure period for each row of a photoelectric conversion unit in the image sensor of a camera. The exposure period in each row is based on the shutter speed set in the camera. In FIG. 2, when the light-emission waveform during the exposure period of row m of the image sensor 102 is compared with the light-emission waveform during the exposure period of row n for the image sensor 102, the emission waveform during the exposure period of row m of the image sensor 102 indicates a lower brightness level than that during exposure period of row n of the image sensor 102. As a result, horizontal stripes caused by variations in brightness of flat light emission may appear in the captured image. This phenomenon is particularly noticeable when the shutter speed is high.

In contrast, the use of silicon carbide (SiC) or gallium nitride (GaN) as a material for the switching element (the switching element 309 in the embodiment) resolves the above issue. These switching elements have lower conduction loss than IGBTs and can be switched at higher frequencies than IGBTs.

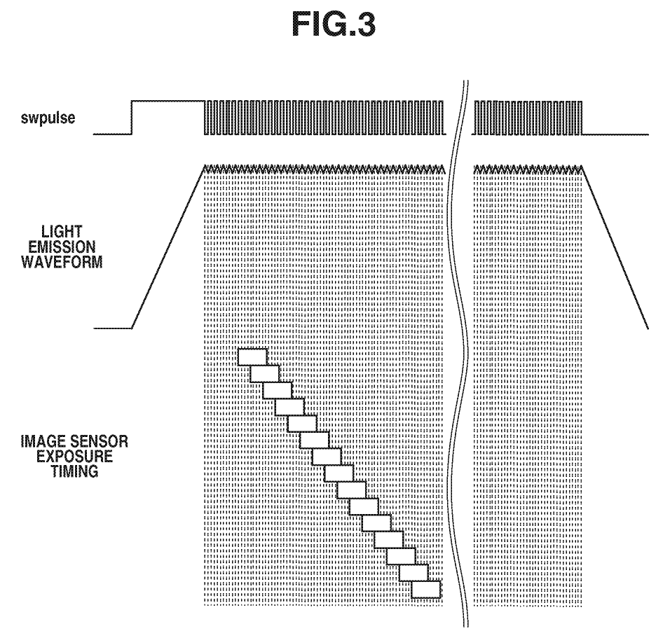

FIG. 3 is a characteristic diagram illustrating the relationship between flat light emission and image-capturing by the image sensor 102 of the camera 100 when the switching element 309 is switched at high speed. In FIG. 3, the shutter speed is set to the same speed as that in FIG. 2, and the exposure period for each row is also the same as in FIG. 2. As illustrated in FIG. 3, the switching occurs a plurality of times within the exposure period of each row of the image sensor 102. Thus, the flashlight received by each row during its exposure period becomes uniform, so that horizontal stripes caused by variations in brightness of flat light emission are reduced or prevented.

### Imaging Control in First Embodiment

The imaging control in the first embodiment will be described below.

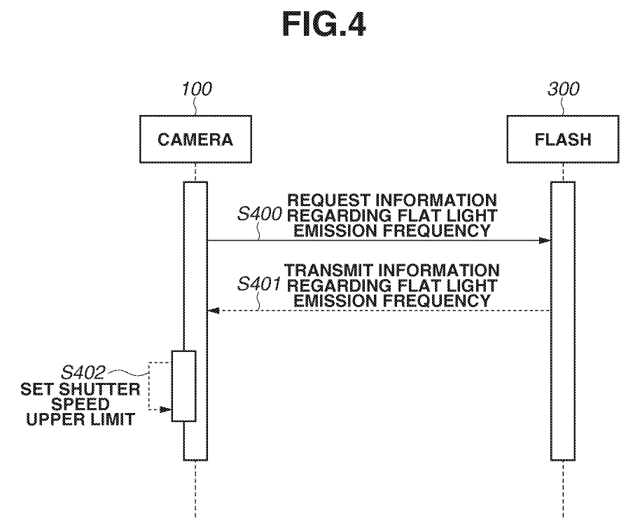

FIG. 4 is a sequence diagram for setting an upper limit of the shutter speed based on information acquired by the camera 100 from the flash 300 in the imaging system according to the embodiment. In this embodiment, high-speed synchronization (sync) photography is enabled according to user settings, and it is assumed that the shutter speed can be set to exceed the flash synchronization speed.

Initially, in step S400, the camera 100 transmits a signal requesting, from the flash 300, information regarding the flat light emission frequency. In the embodiment, the information regarding the flat light emission frequency is information indicating the switching frequency (flat light emission frequency) during the flat light emission performed by the flash 300. Hereinafter, this piece of information is simply referred to as "flat light emission frequency".

In step S401, the flash 300 receives the signal from the camera 100 and transmits information regarding the flat light emission frequency.

In step S402, the camera 100 sets the upper limit of the shutter speed based on the information regarding the flat light emission frequency acquired from the flash 300.

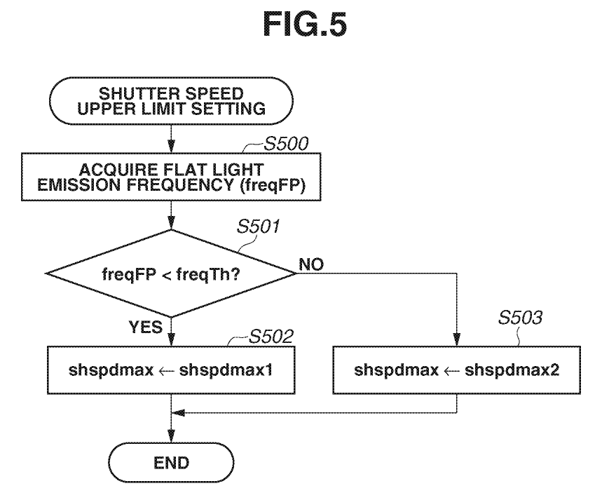

FIG. 5 is a flowchart for setting an upper limit of the shutter speed based on the flat light emission frequency acquired by the camera 100 from the flash 300 in the embodiment.

In step S500, the camera control unit 101 receives the flat light emission frequency from the flash 300. This flat light emission frequency is referred to as freqFP.

With a flash incapable of providing the flat light emission frequency mounted, in the process illustrated in FIG. 4, the camera control unit 101 sets flat light emission frequency freqFP to a value less than a determination threshold freqTh described below. In other words, with a flash incapable of providing the flat light emission frequency mounted, the process proceeds on the assumption that the flat light emission frequency is low.

In step S501, the camera control unit 101 determines whether the flat light emission frequency freqFP received from the flash 300 is less than the predetermined determination threshold freqTh.

If, in step S501, the camera control unit 101 determines that the flat light emission frequency freqFP is less than the determination threshold freqTh (YES, in step S501), the processing proceeds to step S502. In step S502, the camera control unit 101 sets a shutter speed upper limit shspdmax to shspdmax1.

If, in step S501, the camera control unit 101 determines that the flat light emission frequency freqFP is equal to or greater than the determination threshold freqTh (NO, in step S501), the processing proceeds to step S503. In step S503, the following process is performed. The camera control unit 101 determines the shutter speed upper limit shspdmax to be shspdmax2, which is higher than shspdmax1.

Once the shutter speed upper limit shspdmax is determined, the camera control unit 101 ends the processing for setting the upper limit of the shutter speed.

The camera control unit 101 performs various controls based on the determined shutter speed upper limit shspdmax.

In shutter speed priority mode, manual exposure mode, or other modes in all of which the user can set the shutter speed, the user is restricted from setting a shutter speed exceeding the shutter speed upper limit. In aperture priority mode, program AE mode, or other modes in all of which the camera sets the shutter speed, control is performed so that the shutter speed does not exceed the upper limit.

As described above, according to the embodiment, the flat light emission frequency of the flash 300 is obtained, which enables an appropriate upper limit of the shutter speed to be set, thus enabling the camera 100 to reduce or prevent uneven brightness.

### Modification

A modification of the first embodiment will be described below.

The configuration of the imaging system in this modification is similar to that illustrated in FIG. 1 of the embodiment. In this modification, in addition to determination of the magnitude relationship between the flat light emission frequency of the flash 300 and a predetermined threshold, the upper limit of the shutter speed in the camera 100 is determined by identifying the set shutter mode and evaluating shutter efficiency.

### Imaging Control in Modification of First Embodiment

The imaging control in the present modification will be described below.

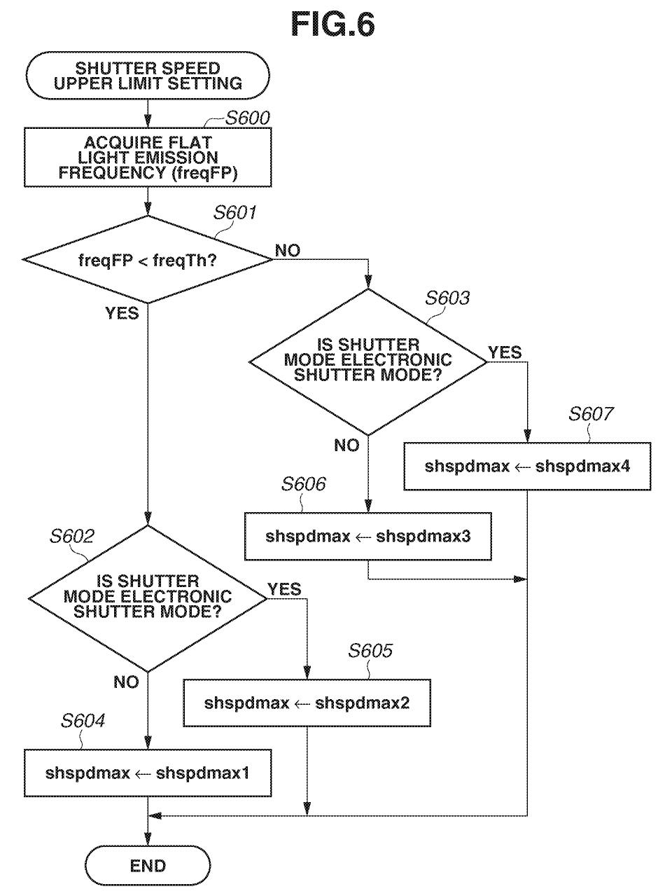

FIG. 6 is a flowchart for setting the upper limit of the shutter speed based on the flat light emission frequency obtained by the camera 100 from the flash 300 in this modification.

In step S600, the camera control unit 101 receives the flat light emission frequency from the flash 300. The flat light emission frequency obtained in this step is referred to as freqFP.

As in the embodiment, with a flash incapable of providing the flat light emission frequency mounted, in the process illustrated in FIG. 4, the camera control unit 101 sets the flat light emission frequency freqFP to a value less than the determination threshold freqTh described below. In other words, with a flash incapable of providing the flat light emission frequency mounted, the processing proceeds on the assumption that the flat light emission frequency is low.

In step S601, the camera control unit 101 determines whether the flat light emission frequency freqFP received from the flash 300 is less than the predetermined determination threshold freqTh.

In step S601, if the flat light emission frequency freqFP is less than the predetermined determination threshold freqTh (YES in step S601), the processing proceeds to step S602. If the flat light emission frequency freqFP is equal to or greater than the predetermined determination threshold freqTh (NO, in step S601), the processing proceeds to step S603.

In step S601, if the flat light emission frequency freqFP is less than the predetermined determination threshold freqTh, then in step S602, the camera control unit 101 determines whether the shutter mode set for the focal plane shutter 104 is the electronic shutter mode.

In step S602, if the camera control unit 101 determines that the shutter mode set for the focal plane shutter 104 is not the electronic shutter mode (i.e., the set shutter mode is the mechanical shutter mode or the electronic front curtain shutter mode) (NO in step S602), the processing proceeds to step S604. In step S604, the camera control unit 101 sets the shutter speed upper limit shspdmax to shspdmax1.

If, in step S602, the camera control unit 101 determines that the shutter mode set for the focal plane shutter 104 is the electronic shutter mode (YES, in step S602), the processing proceeds to step S605. In step S605, the camera control unit 101 determines the shutter speed upper limit shspdmax to be shspdmax2.

In step S601, if the flat light emission frequency freqFP is equal to or greater than the predetermined determination threshold freqTh (NO in step S601), then in step S603, the camera control unit 101 determines whether the shutter mode set for the focal plane shutter 104 is the electronic shutter mode.

In step S603, if the camera control unit 101 determines that the shutter mode set for the focal plane shutter 104 is not the electronic shutter mode (i.e., the set shutter mode is the mechanical shutter mode or the electronic front curtain shutter mode) (NO in step S603), the process proceeds to step S606. In step S606, the camera control unit 101 determines the shutter speed upper limit shspdmax to be shspdmax3.

In step S603, if the camera control unit 101 determines that the shutter mode set for the focal plane shutter 104 is the electronic shutter mode (YES, in step S603), the processing proceeds to step S607. In step S607, the camera control unit 101 determines the shutter speed upper limit shspdmax to be shspdmax4.

With a high flat light emission frequency, the shutter speed can be set to a high value. Thus, shspdmax3 is a higher value than shspdmax1. Similarly, shspdmax4 is a higher value than shspdmax2.

Moreover, the electronic shutter system provides a high shutter efficiency as compared with the mechanical shutter system.

Thus, a low flat light emission frequency is likely to cause unevenness due to variations in brightness of flat light emission in the electronic shutter mode. Accordingly, shspdmax1 for the mechanical shutter mode or the electronic front curtain shutter mode is a higher value than shspdmax2 for the electronic shutter mode. On the other hand, a sufficiently high flat light emission frequency is less likely to cause unevenness due to variations in brightness of flat light emission even in the electronic shutter mode. Generally, the electronic shutter mode allows the shutter speed to be set higher than that in the mechanical shutter mode, so that shspdmax3 for the mechanical shutter mode or the electronic front curtain shutter mode is a lower value than shspdmax4 for the electronic shutter mode.

Accordingly, in this modification, the magnitude relationship among the upper limits of the shutter speed shspdmax is as follows:

shspdmax4 > shspdmax3 > shspdmax1 > shspdmax2.

The relationship among the shutter speeds is not limited to the above, and is determined based on the flat light emission frequency and the performance of each shutter mode.

Once the shutter speed upper limit shspdmax is determined, the camera control unit 101 ends the processing for setting the upper limit of the shutter speed.

In FIG. 6, during the determination in each of steps S602 and S603, the camera control unit 101 determines whether the shutter mode is the electronic shutter mode, and the mechanical shutter mode and the electronic front curtain shutter mode are treated as modes with the same upper limit for the shutter speed. The mechanical shutter mode and the electronic front curtain shutter mode may alternatively be distinguished and assigned different upper limits for the shutter speed.

As described above, according to this modification, the flat light emission frequency of the flash 300 is acquired and the shutter performance is evaluated based on the set shutter mode, so that an appropriate upper limit for the shutter speed can be set, thereby enabling the camera 100 to reduce or prevent the occurrence of uneven brightness.

### Second Embodiment

The second embodiment will now be described. The configuration of the imaging system in the second embodiment is similar to that illustrated in FIG. 1, described in conjunction with the first embodiment. In the embodiment, as information regarding the flat light emission frequency, flag information indicating whether the flat light emission frequency of the flash 300 is a value corresponding to a predetermined high speed is used. As in the first embodiment, high-speed sync photography is enabled according to user settings, and it is assumed that the shutter speed can be set to exceed the flash synchronization speed.

In the embodiment, in step S401 of FIG. 4, the information regarding the flat light emission frequency obtained by the camera 100 is flag information indicating whether the flat light emission frequency of the flash 300 is a predetermined high speed.

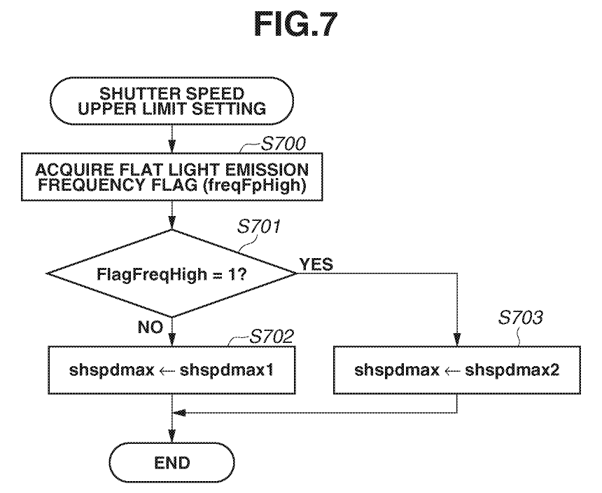

FIG. 7 is a flowchart illustrating the setting of the upper limit of the shutter speed based on flag information indicating whether the flat light emission frequency of the flash 300, obtained by the camera 100 from the flash 300, is a predetermined high speed, in this embodiment.

In step S700, the camera control unit 101 receives flag information, from the flash 300, indicating whether the flat light emission frequency is a predetermined high speed. This flag information is referred to as FlagFreqHigh. If the flat light emission frequency is high, FlagFreqHigh is “1”; if the flat light emission frequency is not high, FlagFreqHigh is “0”.

With a flash incapable of providing the flag information mounted, in the process illustrated in FIG. 4, the camera control unit 101 sets FlagFreqHigh to “0”. In other words, with a flash incapable of providing the flag information mounted, the processing proceeds on the assumption that the flat light emission frequency is low.

In step S701, the camera control unit 101 determines whether the flag information FlagFreqHigh received from the flash 300 is “1”.

If, in step S701, the camera control unit 101 determines that the flag information FlagFreqHigh is not “1” (i.e., it is “0”) (NO in step S701), specifically, the flat light emission frequency is not a high speed, the process proceeds to step S702. In step S702, the camera control unit 101 sets the shutter speed upper limit shspdmax to shspdmax1.

If, in step S701, the camera control unit 101 determines that the flag information FlagFreqHigh is “1” (YES, in step S701), in other words, the flat light emission frequency is high, the processing proceeds to step S703. In step S703, the camera control unit 101 sets the shutter speed upper limit shspdmax to shspdmax2, which is higher than shspdmax1.

Once the shutter speed upper limit shspdmax is determined, the camera control unit 101 ends the processing for setting the upper limit of the shutter speed.

As described above, according to the embodiment, flag information indicating whether the flat light emission frequency is high is obtained from the flash 300, so that an appropriate upper limit for the shutter speed can be set, thereby enabling the camera 100 to reduce or prevent the occurrence of uneven brightness.

### Modification

A modification of the second embodiment will now be described.

The configuration of the imaging system in this modification is similar to that illustrated in FIG. 1 described in conjunction with the first embodiment. In this modification, in addition to determining the flat light emission frequency of the flash 300 in the flag information, the upper limit of the shutter speed in the camera 100 is determined by identifying the set shutter mode and determining shutter efficiency.

### Imaging Control in Modification of Second Embodiment

The imaging control in the modification will now be described.

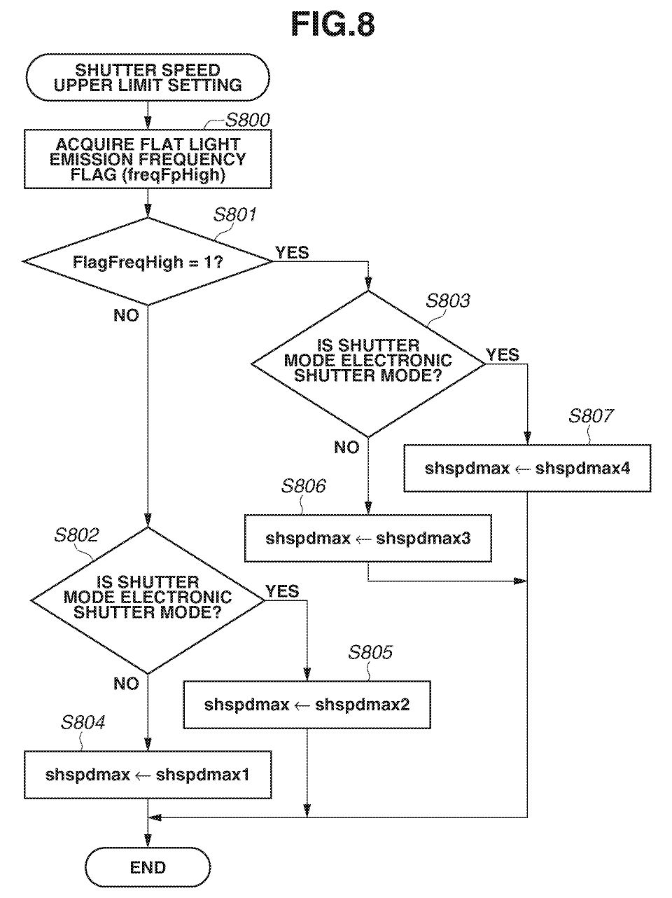

FIG. 8 is a flowchart for setting an upper limit of the shutter speed based on flag information indicating whether the flat light emission frequency of the flash 300, obtained by the camera 100 from the flash 300, is higher than a predetermined value, in this modification.

In step S800, the camera control unit 101 receives flag information, from the flash 300, indicating whether the flat light emission frequency is higher than a predetermined value. This flag information is referred to as FlagFreqHigh. If the flat light emission frequency is higher than the predetermined value, FlagFreqHigh is “1”; if the flat light emission frequency is not higher than the predetermined value, FlagFreqHigh is “0”.

With a flash incapable of providing flag information mounted, in the process illustrated in FIG. 4, the camera control unit 101 sets the flag information FlagFreqHigh to “0”. That is, with a flash incapable of providing flag information mounted, the processing proceeds on the assumption that the flat light emission frequency is low.

In step S801, the camera control unit 101 determines whether FlagFreqHigh received from the flash 300 is “1”.

If, in step S801, the camera control unit 101 determines that the flag information FlagFreqHigh is not “1” (i.e., it is “0”) (NO in step S801), specifically, the flat light emission frequency is not a high speed, the processing proceeds to step S802. In contrast, in step S801, if the camera control unit 101 determines that the flag information FlagFreqHigh is “1” (YES in step S801), specifically, the flat light emission frequency is a high speed, the processing proceeds to step S803.

In step S802, as in step S602 of FIG. 6 in the first embodiment, the camera control unit 101 determines whether the shutter mode set for the focal plane shutter 104 is the electronic shutter mode.

In step S802, if the camera control unit 101 determines that the shutter mode set for the focal plane shutter 104 is not the electronic shutter mode (NO, in step S802) (i.e., it is the mechanical shutter mode or the electronic front curtain shutter mode), the processing proceeds to step S804. In step S804, the camera control unit 101 sets the shutter speed upper limit shspdmax to shspdmax1.

In step S802, if the camera control unit 101 determines that the shutter mode set for the focal plane shutter 104 is the electronic shutter mode (YES, in step S802), the processing proceeds to step S805. In step S805, the camera control unit 101 sets the shutter speed upper limit shspdmax to shspdmax2.

In step S803, the camera control unit 101 determines whether the shutter mode set for the focal plane shutter 104 is the electronic shutter mode.

In step S803, if the camera control unit 101 determines that the shutter mode set for the focal plane shutter 104 is not the electronic shutter mode (NO, in step S803) (i.e., it is the mechanical shutter mode or the electronic front curtain shutter mode), the processing proceeds to step S806. In step S806, the camera control unit 101 sets the shutter speed upper limit shspdmax to shspdmax3.

In step S803, if the camera control unit 101 determines that the shutter mode set for the focal plane shutter 104 is the electronic shutter mode (YES, in step S803), the processing proceeds to step S807. In step S807, the camera control unit 101 sets the shutter speed upper limit shspdmax to shspdmax4.

In this modification, as in the modification of the first embodiment, the magnitude relationship among the upper limits of the shutter speed shspdmax is as follows:

shspdmax4 > shspdmax3 > shspdmax1 > shspdmax2

Once the camera control unit 101 determines the shutter speed upper limit shspdmax, the camera control unit 101 ends the processing for setting the upper limit of the shutter speed.

As described above, according to this modification, flag information indicating whether the flat light emission frequency is higher than a predetermined value is obtained from the flash 300 and the shutter performance is determined based on the set shutter mode. This enables an appropriate upper limit for the shutter speed to be set, thereby achieving the camera 100 capable of reducing or preventing the occurrence of uneven brightness.

### Other Embodiments

In the above-described various embodiments, a computer program for controlling the imaging system is stored in a storage medium such as the storage unit 110. This computer program is a control program for realizing various functions of the CPU of the camera control unit 101. Specifically, the program corresponds to the steps illustrated in FIGS. 5 to 8 among other processes. In FIG. 5, the control program corresponds to steps S500 to S503; in FIG. 6, to steps S600 to S607; in FIG. 7, to steps S700 to S703; and in FIG. 8, to steps S800 to S807. The CPU of the camera control unit 101, which serves as a computer, reads and executes the computer program from a storage medium such as the storage unit 110. The various embodiments can also be realized by supplying this computer program to a system or device via a network or storage medium, and having one or more processors in the computer of the system or device read and execute the program. Furthermore, the functions can also be realized by a circuit (e.g., Application Specific Integrated Circuit [ASIC]) that implements one or more functions. The program code itself read from the recording medium realizes the functions of the above-described embodiments, and the recording medium storing the program code constitutes the disclosure.

While various embodiments of the disclosure have been described above, the disclosure is not limited to these embodiments, and various modifications and changes can be made within the scope of the gist of the disclosure.

Embodiment(s) of the disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-022760, filed February 14, 2025, which is hereby incorporated by reference herein in its entirety.

What is claimed is:

1. A control device comprising:
an acquisition unit configured to acquire information regarding an emission frequency of a light emission device; and
a determination unit configured to determine imaging settings,
wherein the determination unit determines an upper limit of a shutter speed that is settable among the imaging settings based on the information.

2. The control device according to claim 1,
wherein the acquisition unit includes a communication unit configured to communicate with the light emission device, and
wherein the acquisition unit acquires the information regarding the emission frequency of the light emission device by communicating with the light emission device via the communication unit.

3. The control device according to claim 1, wherein the information is the emission frequency of the light emission device.

4. The control device according to claim 3, wherein the determination unit determines the upper limit of the shutter speed based on whether the emission frequency is equal to or greater than a predetermined threshold.

5. The control device according to claim 4, wherein the determination unit sets the upper limit of the shutter speed to a first value in a case where the emission frequency is less than the predetermined threshold, and sets the upper limit of the shutter speed to a second value which is higher than the first value in a case where the emission frequency is equal to or greater than the predetermined threshold.

6. The control device according to claim 5, wherein, in a case where the emission frequency is not acquirable by the acquisition unit, the determination unit sets the upper limit of the shutter speed to the first value.

7. The control device according to claim 3, wherein the determination unit determines the upper limit of the shutter speed based on whether the emission frequency is equal to or greater than a predetermined threshold and on a shutter mode set as an imaging setting of the imaging setting.

8. The control device according to claim 7, wherein the shutter mode includes at least one of a mechanical shutter mode, an electronic shutter mode, and an electronic front curtain shutter mode.

9. The control device according to claim 7, wherein, in a case where the emission frequency of the light emission device is not acquirable by the acquisition unit, the determination unit determines the upper limit of the shutter speed with the emission frequency treated as being less than the predetermined threshold.

10. The control device according to claim 1, wherein the information regarding the emission frequency is flag information for the emission frequency of the light emission device.

11. The control device according to claim 10, wherein the determination unit determines the upper limit of the shutter speed based on whether the flag information corresponds to information indicating that the emission frequency of the light emission device is higher than a predetermined value.

12. The control device according to claim 11, wherein the determination unit sets the upper limit of the shutter speed to a first value in a case where the flag information corresponds to information indicating that the emission frequency of the light emission device is not higher than the predetermined value, and sets the upper limit of the shutter speed to a second value which is higher than the first value in a case where the flag information corresponds to information indicating that the emission frequency of the light emission device is higher than the predetermined value.

13. The control device according to claim 12, wherein, in a case where the flag information is not acquirable by the acquisition unit, the determination unit sets the upper limit of the shutter speed to the first value.

14. The control device according to claim 10, wherein the determination unit determines the upper limit of the shutter speed based on the flag information and a shutter mode set as an imaging setting of the imaging settings.

15. The control device according to claim 14, wherein the shutter mode includes at least one of a mechanical shutter mode, an electronic shutter mode, and an electronic front curtain shutter mode.

16. The control device according to claim 14, wherein, in a case where the flag information is not acquirable by the acquisition unit, the determination unit determines the upper limit of the shutter speed with the flag information treated as corresponding to information indicating that the emission frequency of the light emission device is not higher than a predetermined value.

17. A method for controlling a control device, the method comprising:
acquiring information regarding a emission frequency of a light emission device; and
determining imaging settings,
wherein an upper limit of a shutter speed that is settable among the imaging settings is determined based on the information.

18. The method according to claim 17,
wherein the acquiring includes communicating with the light emission device, and
wherein the acquiring acquires the information regarding the emission frequency of the light emission device by communicating with the light emission device via the communicating.

19. A non-transitory computer-readable storage medium storing a program for causing a computer to execute the method for controlling the control device, the method comprising:
acquiring information regarding a emission frequency of a light emission device; and
determining imaging settings, wherein an upper limit of a shutter speed that is settable among the imaging settings is determined based on the information.

20. The non-transitory computer-readable storage medium according to claim 19,
wherein the acquiring includes communicating with the light emission device, and
wherein the acquiring acquires the information regarding the emission frequency of the light emission device by communicating with the light emission device via the communicating.
